(19) United States
(12) Patent Application Publication
(10) Pub. No.: US 2006/0225961 A1
(43) Pub. Date: Oct. 12, 2006

(54) Kitchen ladder

(76) Inventor: Gary T. Elliott, Warrenton, VA (US)

Correspondence Address: LITMAN LAW OFFICES, LTD, PO BOX 15035, CRYSTAL CITY STATION, ARLINGTON, VA, 22215, US

(21) Appl. No.: 11/368,606

(22) Filed: Mar. 7, 2006

Related U.S. Application Data
(60) Provisional application No. 60/663,745, filed on Mar. 22, 2005.

(51) Int. Cl. E06C 1/00

(52) U.S. Cl. 182/161

(57) ABSTRACT

The kitchen ladder is adapted and contoured for stable placement against a counter, allowing users to access cabinets without slipping. The ladder has a pair of elongated, parallel side rails and a plurality of parallel steps extending between the side rails. The upper portion of each of the side rails has a recess defined within it that is lined with a strip of non-slipping material. The recesses are adapted to engage a kitchen countertop. The ladder is angled in order to stabilize the ladder against counter edges.

### CROSS-REFERENCE TO RELATED APPLICATION

This application claims the benefit of U.S. Provisional Patent Application Ser. No. 60/663,745, filed Mar. 22, 2005.

### BACKGROUND OF THE INVENTION

1. Field of the Invention

The present invention relates to ladders and, particularly to a kitchen ladder engageable with a kitchen countertop.

2. Description of the Related Art

Accessing kitchen cabinets is troublesome for numerous individuals, especially those who are shorter in stature. Shorter adults and children often require assistance in reaching cabinets that are wall mounted above a kitchen countertop in order to acquire dishes, glasses and the like. Children sometimes resort to crawling onto the countertop, or standing on the countertop, to access the necessary items. These activities are quite dangerous and may cause children to injure themselves.

Many adults either do not place necessary items in the difficult to reach cabinets, or they are forced to use chairs, stools or other types of furniture for accessing the cabinet items. Chairs and stools, however, are fairly large and bulky. As they tend to be wide, situating a chair or a stool against a kitchen counter does not necessarily allow the individual to move close enough to the counter to reach necessary items. Chairs and stools may slip, are not entirely stable, and may not be high enough for users to access their cabinets. Also, most chairs and stools do not store particularly easily, so that if they are needed and are not readily accessible, they must be found in a storage area large enough to hold them.

Ladders may be used to access the cabinets, but ladders tend to be either too large for indoor use or unstable when positioned against the side of a counter. Such ladders tend to be fairly unwieldy and may damage the countertop. Further, when placed against a countertop, even small ladders are unstable, as they may easily slip against the edge of the counter.

The OSHA-required angle for a ladder is 75.5°, which allows for the highest level of safety for ladder use. Ladders that are not angled at their base require the user to stand the ladder at the appropriate angle against the side of the counter for maximum safety. However, if the base of the ladder is not also angled, or the steps of the ladder are not also angled, the ladder will not be as stable as possible when set against the edge of the counter.

Accordingly, there is a need for a ladder that provides both stability and accessibility, and additionally may be easily stored. Thus, a kitchen ladder solving the aforementioned problems is desired.

### SUMMARY OF THE INVENTION

The kitchen ladder, designed to be supported against a counter to allow users to access cabinets, has a pair of elongated parallel side rails and a plurality of parallel steps extending between the side rails. The upper portion of each of the side rails has a recess defined therein. The recesses are adapted for engaging kitchen counters. The recesses are lined with strips of material that have a high coefficient of friction so that when the ladder is placed against the counter, the ladder is stabilized against the countertop.

The bottom of each side rail is also lined with strips of material that have a high coefficient of friction, so that when the side rails engage the floor, the ladder does not slide on the floor. The side rails and the parallel steps are angled to about 75.5°, providing a high level of stability when the ladder is placed against the counter. Additionally, a hand rung or grab bar is located between the upper portions of each of the side rails, so that a user may grasp the hand rung when climbing the kitchen ladder for increased steadiness.

These and other features of the present invention will become readily apparent upon further review of the following specification and drawings.

### BRIEF DESCRIPTION OF THE DRAWINGS

FIG. 1 is an environmental, perspective view of a kitchen ladder according to the present invention.

FIG. 2 is a front perspective view of the kitchen ladder according to the present invention.

FIG. 3 is a rear perspective view of the kitchen ladder according to the present invention.

Similar reference characters denote corresponding features consistently throughout the attached drawings.

### DETAILED DESCRIPTION OF THE PREFERRED EMBODIMENT

The present invention is a kitchen ladder adapted to engage a kitchen counter. The kitchen ladder, designated generally as 10 in the drawings, is set against the counter and allows the user to access cabinets without the ladder slipping.

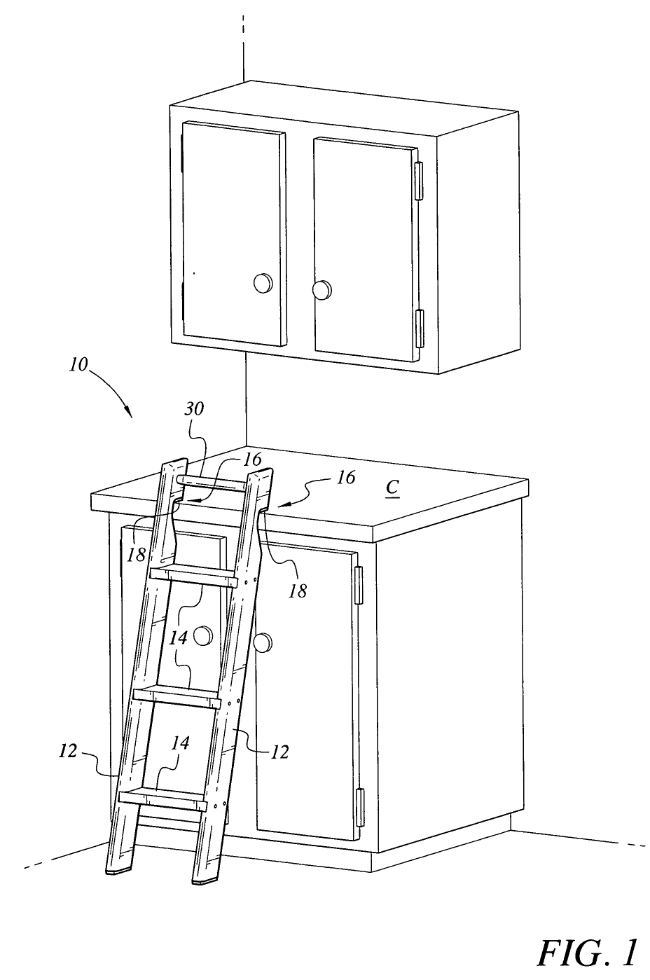

Referring now to FIG. 1, an environmental perspective view of the kitchen ladder 10 is shown. The kitchen ladder 10 has a pair of elongated parallel side rails 12 and a plurality of parallel steps 14 extending between the side rails 12. The side rails 12 are engageable with a floor surface so that the ladder 10 is stabilized. The parallel side rails 12 each have a recess 16 defined therein that is adapted for engaging the kitchen counter C. The recesses 16 are each lined with a counter-engaging strip of material 18.

The kitchen ladder 10 is placed adjacent to the kitchen counter C and the recesses 16 abut the edge of the counter C. The counter-engaging strips of material 18 have a high coefficient of friction, so that when the ladder 10 is placed against the counter C, the ladder 10 is held steady with respect to, and is supported by, the counter C, preventing the ladder 10 from slipping.

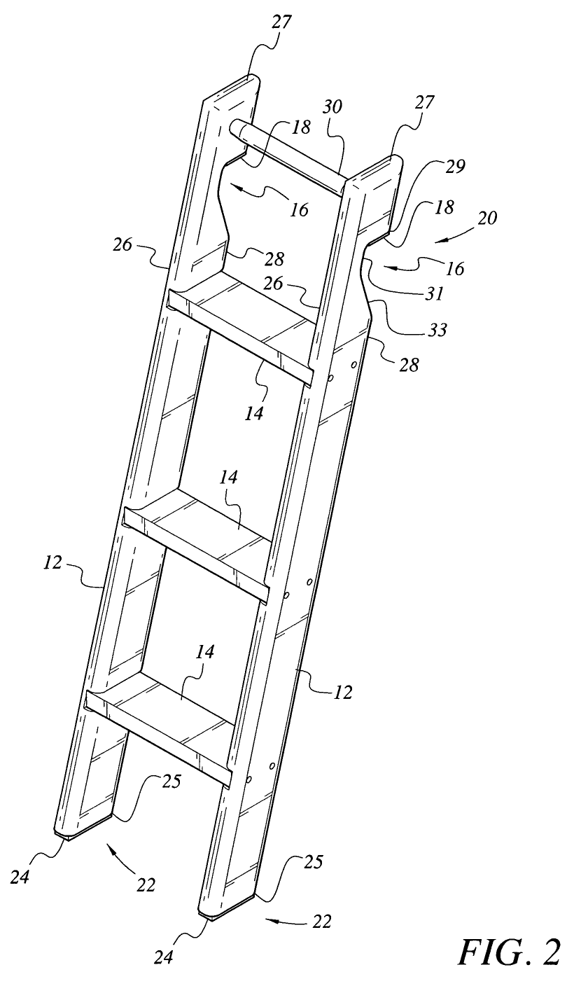

With reference to FIG. 2, a front perspective view of the kitchen ladder 10 is shown. The ladder 10 has elongated parallel side rails 12 that are adapted to engage the floor. A plurality of parallel steps 14 extend between the side rails 12. The side rails 12 each have an upper portion 20 and a lower portion 22, the lower portion 22 being adapted for engaging a floor. The lower portion 22 of each of the side rails 12 has a bottom edge or surface 25 lined with a floor-engaging strip of material 24 that has a high coefficient of friction, similar to the counter-engaging strips of material 18 in the recesses 16.

Each side rail 12 includes a forward edge 26 and a rearward edge 28. Further, each side rail 12 includes an upper edge 27, which is angled to be substantially parallel with the bottom edges 25. The upper portion 20 of the rearward edge 28 of each side rail 12 has a recess 16 defined therein adapted to engage a counter. The recess 16 may be of any dimension to allow for the engagement of an edge of a kitchen counter. The recesses 16 are lined with counter-engaging strips of material 18.

In the embodiment shown in the drawings, which is shown for exemplary purposes only, each recess 16 is defined by an upper wall 29, a middle wall 31 and a lower wall 33. As shown, upper wall 29 is angled to be substantially parallel with the upper edge 27 of rail 12. The middle wall 31 is oriented substantially orthogonal to upper wall 29, such that the upper surface of counter C contacts upper wall 29 and the side surface of counter C contacts middle wall 31, as shown in FIG. 1. Lower wall 31 is angled to allow for reception and engagement with a wide variety of contoured counters C. The contour shown in the drawings is exemplary, however, and any recess, notch, or the like adapted for engaging the top and/or the side edge of a kitchen countertop is within the scope of the present invention. As shown, frictional elements 18 may be adhered or otherwise mounted to the upper walls 29, or may, alternatively, also cover central walls 31 or lower walls 33.

Additionally, a grip bar or hand rung 30 extends between the upper portion 20 of each of the side rails 12, so that a user may grasp the hand rung 30 when climbing the kitchen ladder 10 for increased steadiness. The kitchen ladder 10 is angled to about 75.5°, but may be angled to between 65° and 85° or angled at any degree that would allow the ladder 10 to engage with the kitchen counter. The side rails 12 and the steps 14 are all angled to 75.5°.

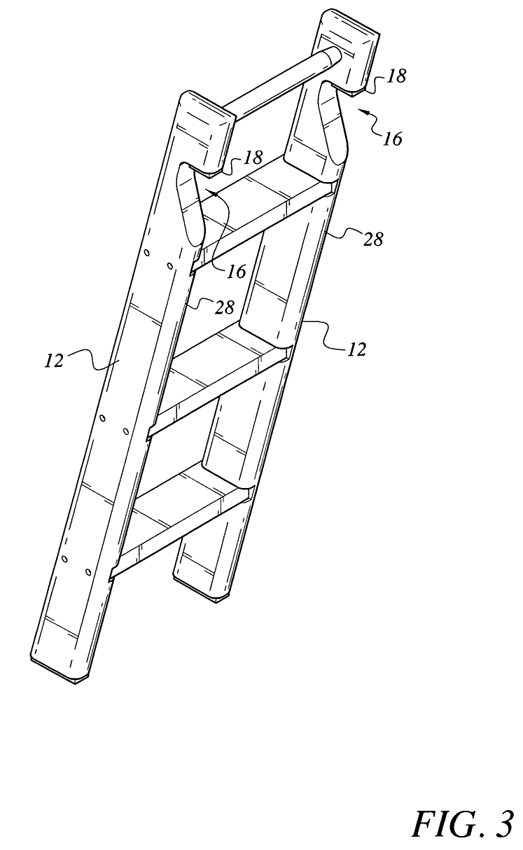

Turning now to FIG. 3, a rear perspective view of the kitchen ladder 10 is shown. The recesses 16 are defined within the rearward edge 28 of the side rails 12. Although one section of the recesses 16 is shown lined with the counter-engaging material 18, the entire recess 16 may be lined with the material 18, depending on the stability necessary for maintaining the kitchen ladder 10 securely against a counter.

It is to be understood that the present invention is not limited to the embodiment described above, but encompasses any and all embodiments within the scope of the following claims.

I claim:

1. A kitchen ladder, comprising:
a pair of elongated parallel side rails, each of the side rails having an upper portion, a lower portion adapted for engaging a floor, a forward edge, and a rearward edge, the rearward edge of the upper portion of each side rail having a recess defined therein adapted for engaging a countertop;
a plurality of parallel steps extending between the side rails; and
a counter-engaging strip of material having a high coefficient of friction lining the recess of each of the side members for preventing the ladder from slipping when engaging the countertop.

2. The kitchen ladder according to claim 1, wherein the side rails have bottom edges forming an angle of between 65° and 85° relative to the axial length of the side rails.

3. The kitchen ladder according to claim 1, wherein the steps form an angle of between 65° and 85° relative to the axial length of the side rails.

4. The kitchen ladder according to claim 1, further comprising a hand rung extending between said pair of elongated parallel side rails, said hand rung being positioned adjacent upper edges of said pair of elongated parallel side rails and being adapted for grasping by a user.

5. The kitchen ladder according to claim 1, wherein each of said recesses is defined by an upper wall and a central wall, said upper wall being oriented substantially parallel to upper edges of said pair of elongated parallel side rails, said central wall being oriented substantially orthogonal to said upper wall, whereby said upper wall is adapted for engaging an upper surface of the countertop and said central wall is adapted for engaging a side surface of the countertop.

6. The kitchen ladder according to claim 5, wherein said counter-engaging strip of material is mounted to the upper wall of said recess.

7. The kitchen ladder according to claim 5, wherein each said recess is further defined by a lower wall, the lower wall being oriented so that the lower wall forms an obtuse angle with respect to the central wall.

8. The kitchen ladder according to claim 1, further comprising a pair of frictional elements mounted to a bottom surface of a respective one of said pair of elongated parallel side rails for frictionally engaging a support surface.
